(19) United States
(12) Patent Application Publication
(10) Pub. No.: US 2022/0001857 A1
(43) Pub. Date: Jan. 6, 2022

(54) PARKING ASSISTANCE DEVICE, VEHICLE, PARKING ASSISTANCE METHOD, AND NON-TRANSITORY COMPUTER-READABLE MEDIUM

(71) Applicant: PANASONIC INTELLECTUAL PROPERTY MANAGEMENT CO., LTD., Osaka (JP)

(72) Inventor: Daiki HAMADA, Tokyo (JP)

(73) Assignee: PANASONIC INTELLECTUAL PROPERTY MANAGEMENT CO., LTD., Osaka (JP)

(21) Appl. No.: 17/479,592

(22) Filed: Sep. 20, 2021

Related U.S. Application Data
(63) Continuation of application No. PCT/JP2020/007879, filed on Feb. 26, 2020.

(30) Foreign Application Priority Data
Mar. 22, 2019 (JP) 2019-055269

(51) Int. Cl. B60W 30/06; B60T 7/12; B60W 30/09

(52) U.S. Cl. CPC B60W 30/06; B60T 7/12; B60W 30/09; B60W 2554/801; B60W 2720/125; B60W 2720/10; B60W 2720/12; B60W 2720/106; B60W 2554/802

(57) ABSTRACT

A parking assistance device includes a processor and a memory having instructions. The instructions, when executed by the processor, cause the parking assistance device to perform operations. The operations include: calculating a parking route to generate parking route information; and changing a stop determination distance parameter included in an automatic parking parameter based on obstacle information input to the parking assistance device and the parking route information.

### CROSS-REFERENCE TO RELATED APPLICATIONS

This application is a continuation of PCT International Patent Application No. PCT/JP2020/007879 filed on Feb. 26, 2020, which claims the benefit of priority of Japanese Patent Application No. 2019-055269 filed on Mar. 22, 2019, the entire contents of which are incorporated herein by reference.

### FIELD

The present disclosure relates to a parking assistance device.

The present disclosure also relates to a vehicle including a parking assistance device, a parking assistance method, and a parking assistance program.

### BACKGROUND

JP-A-2008-143337 discloses that, in a vehicle that includes an automatic traveling device and an automatic braking device, in order to provide a vehicle control device capable of appropriately performing control of the vehicle by coordinating both devices, a vehicle control device controlling a vehicle, which includes an automatic travel device that causes a vehicle to travel automatically and an automatic braking device that automatically brakes the vehicle when an obstacle is detected, is provided with a travel output setting unit that reduces a travel output of the automatic travel device to be smaller than a normal output when the obstacle is detected.

JP-A-2017-214011 discloses that, in order to provide a technique capable of executing appropriate automatic braking at the time of parking a vehicle, a parking assistance device according to an aspect of the present disclosure includes: a plurality of object detection sensors that detect an object in surroundings of an own vehicle; a parking area detection unit that detects a parking area; and a braking execution determination unit that determines execution of braking of the own vehicle when the plurality of object detection sensors detect that an object is located in a first detection range. At the time of parking the own vehicle in the parking area, the braking execution determination unit determines execution of braking of the own vehicle when the object detection sensor detects that an object is located in a second detection range that is larger than the first detection range. The second detection range is enlarged outward in a vehicle width direction from a vehicle width of the own vehicle.

### SUMMARY

The present disclosure provides a parking assistance device including: a processor; and a memory having instructions that, when executed by the processor, cause the parking assistance device to perform operations including: calculating a parking route to generate parking route information; and changing a stop determination distance parameter included in an automatic parking parameter based on obstacle information input to the parking assistance device and the parking route information.

The present disclosure provides a vehicle including: a parking assistance device including a processor and a memory; and a detector, wherein the instructions, when executed by the processor, cause the parking assistance device to perform operations including: calculating a parking route to generate parking route information; and changing a stop determination distance parameter included in an automatic parking parameter based on obstacle information related to an obstacle detected by the detector input to the parking assistance device and the parking route information.

The present disclosure provides a parking assistance method used by a parking assistance device, the parking assistance method including: calculating a parking route to generate parking route information; and changing a stop determination distance parameter included in an automatic parking parameter based on obstacle information input to the parking assistance device and the parking route information.

The present disclosure provides a non-transitory computer-readable medium storing a parking assistance program that, when executed by a processor, causes a computer to perform operations including: calculating a parking route to generate parking rout information; and changing a stop determination distance parameter included in an automatic parking parameter based on obstacle information input to the computer and the parking route information.

### BRIEF DESCRIPTION OF DRAWINGS

FIGS. 1A and 1B are conceptual diagrams illustrating automatic parking in the related art, in which FIG. 1A illustrating automatic parking to a normal space, and FIG. 1B illustrating automatic parking to a narrow space.

FIG. 2 is a conceptual diagram illustrating automatic parking of a vehicle including a parking assistance device 1 according to the present disclosure.

FIG. 3 is a configuration diagram illustrating a vehicle including the parking assistance device 1 according to an embodiment of the present disclosure.

FIG. 4 is a flowchart illustrating an example of automatic parking processing performed in a vehicle including the parking assistance device 1 according to the present disclosure.

FIG. 5 is an illustrative diagram of a distance d and a thresholds between a parking path and a surrounding obstacle.

FIG. 6 is a diagram illustrating a change example of an automatic parking parameter.

### DETAILED DESCRIPTION

### Introduction to the Present Disclosure

A vehicle having an automatic parking function already exists. In the automatic parking function, a vehicle side automatically performs reversing, curving, and the like of the vehicle without a driver of the vehicle performing a steering wheel operation or an accelerator operation. In addition, parking assistance (parking assist) or the like in which steering is automatically performed and drive is performed by a driver may also be included in the above-described automatic parking.

From a viewpoint of safety at the time of automatic parking, an obstacle stop function may be added to the automatic parking function. With respect to the obstacle stop function, for example, the vehicle has a predetermined distance from the vehicle as a stop determination distance parameter, and when it is detected that an obstacle is present within the predetermined distance, automatic braking is activated to automatically stop the vehicle. By having the obstacle stop function, safety in automatic parking is guaranteed.

In a parking lot or the like, a distance from a vehicle to an obstacle such as an adjacent vehicle may be less than the predetermined distance described above. Hereinafter, such a space in a parking lot or the like is referred to as a narrow space.

In a case of a vehicle having the above-described obstacle stop function, even when an attempt is made to perform automatic parking in the narrow space, a sensor may react to an adjacent vehicle, a wall surface existing in the vicinity, or the like so that automatic braking is activated, and the vehicle may stop before parking is completed. That is, the automatic parking cannot be completed.

The present disclosure provides a parking assistance device capable of completing automatic parking even in a narrow space.

Hereinafter, a detailed description will be given with reference to the drawings as appropriate. Note that the accompanying drawings and the following description are provided for a thorough understanding of the present disclosure by those skilled in the art, and are not intended to limit the subject matter recited in the claims.

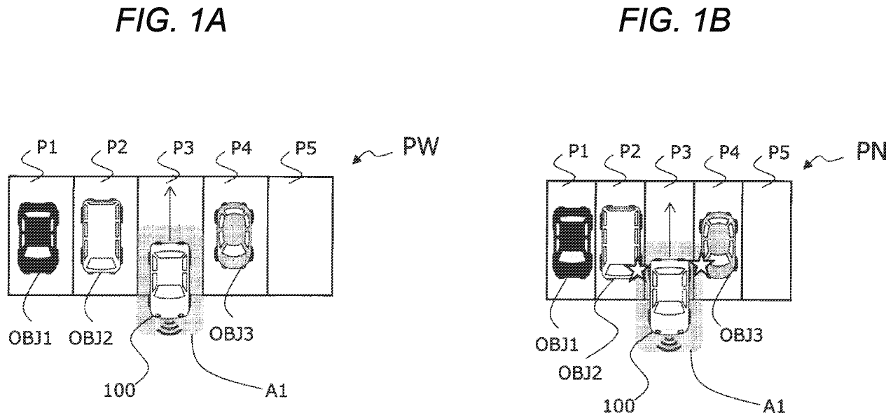

FIGS. 1A and 1B are conceptual diagrams illustrating automatic parking in the related art, in which FIG. 1A illustrates automatic parking to a normal space and FIG. 1B illustrates automatic parking to a narrow space.

In a parking lot PW illustrated in FIG. 1A, five parking spaces P1 to P5 are arranged side by side. A vehicle 100 is about to reverse and perform automatic parking. The vehicle 100 has an obstacle stop function. An area A1 shown around the vehicle 100 is an area corresponding to the stop determination distance described above, and when an obstacle is present in the area A1, automatic braking is activated and the vehicle 100 is stopped.

Three other vehicles are present in the parking spaces P1, P2, and P5. These three vehicles may be obstacles OBJ1 to OBJ3 for the vehicle 100 depending on a situation. Note that an obstacle for the vehicle 100 is not limited to other vehicles. For example, a fence, a wall, or the like of an adjacent building may also be an obstacle.

In a situation illustrated in FIG. 1A, the parking spaces P1 to P5 each have a large space size in a width direction. Therefore, there is no obstacle within the stop determination distance of the vehicle 100. Therefore, the automatic braking of the vehicle 100 is not activated, and the vehicle 100 can complete the automatic parking.

On the other hand, in the case of the narrow space of FIG. 1B, the situation is different from the above.

A parking lot PN illustrated in FIG. 1B is the same as the parking lot PW in that five parking spaces P1 to P5 are present, the vehicle 100 is about to perform automatic parking, and other vehicles are present.

However, in the parking lot PN illustrated in FIG. 1B, a width of the parking spaces P1 to P5 is narrow. That is, each of the parking spaces P1 to P5 is a narrow space.

Then, since the obstacles OBJ2 and OBJ3, which are other vehicles, enter within the stop determination distance of the vehicle 100, the vehicle 100 activates automatic braking and stops on the spot. That is, the automatic parking to the parking space P3 is not completed.

Next, a case of automatic parking by the parking assistance device of the present disclosure will be described.

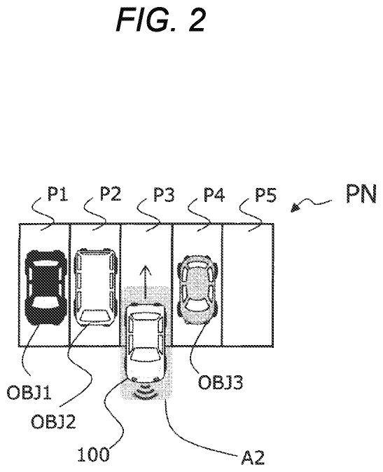

FIG. 2 is a conceptual diagram illustrating automatic parking of a vehicle including a parking assistance device 1 according to the present disclosure.

As illustrated in the drawing, the stop determination distance can be reduced by using a parking assistance device 1 (described later) according to the present disclosure. As a result, the area A1 illustrated in FIG. 1B becomes a narrower area A2. Therefore, even in a narrow space, automatic parking can be safely completed without colliding with surrounding obstacles (OBJ2 and OBJ3 in this example). Hereinafter, a configuration for implementing this will be described in detail.

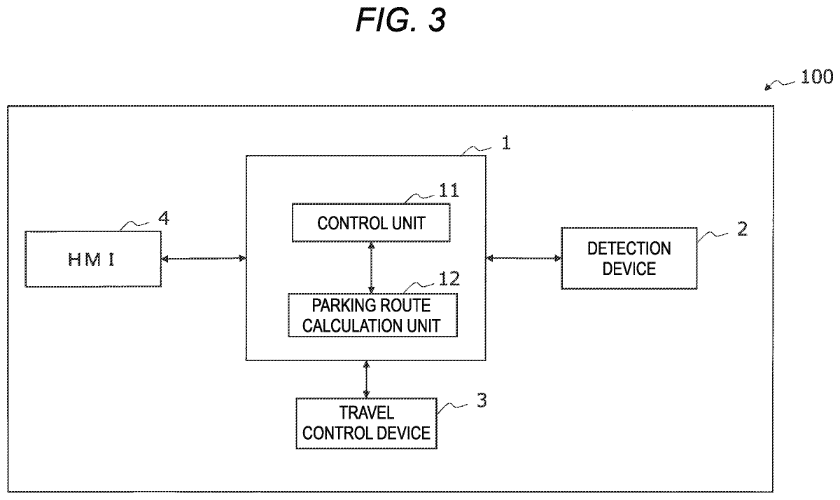

FIG. 3 is a configuration diagram illustrating a vehicle including the parking assistance device 1 according to an embodiment of the present disclosure. The vehicle 100 includes the parking assistance device 1 of the present disclosure. The vehicle 100 includes a detection device 2, a travel control device 3, a human machine interface (HMI) 4, and the like. Note that the vehicle 100 may include other components.

The parking assistance device 1 includes a control unit 11 and a parking route calculation unit 12. The parking assistance device 1 may include a memory that stores a software program and various parameters necessary for executing an operation of the parking assistance device 1. The parking assistance device 1 may include other components such as a communication interface. The parking assistance device 1 is connected to the detection device 2, the travel control device 3, the HMI 4, and the like, and transmits and receives information and commands to and from these components.

The control unit 11 may store an automatic parking parameter in the memory or the like. The automatic parking parameter includes a value of the stop determination distance described above. In addition, the automatic parking parameter may further include a target speed, an acceleration, a deceleration, a proportional-integral-derivative (PID) gain, a stop target distance of automatic braking, a time-to-collision (TTC) setting time of automatic braking, and the like of the vehicle 100. The automatic parking parameter may include other parameters.

The control unit 11 controls automatic parking of the vehicle 100. The parking assistance device 1 may be configured using, for example, a single or a plurality of electronic control units (ECU).

The detection device 2 is a device that detects an obstacle for the vehicle 100. The detection device 2 may be a rear camera attached to the vehicle 100, a sonar, a radar, a light detection and ranging (LIDAR), or the like. However, the present disclosure is not limited thereto. The detection device 2 can detect an obstacle outside the vehicle 100. When an obstacle outside the vehicle 100 is detected, the detection device 2 transmits obstacle information to the parking assistance device 1. The obstacle information may contain position information of the detected obstacle, information on a distance from the vehicle 100 to the obstacle, and the like. Note that the obstacle information may contain other types of information.

The travel control device 3 is a device that controls an accelerator, a brake, a steering wheel, and the like of the vehicle 100. By control of the travel control device 3, movement of the vehicle 100 related to the automatic parking is performed.

The HMI 4 is a device that presents information to an occupant of the vehicle 100 and receives information input from the occupant, and is typically a touch panel monitor provided on a front panel of the vehicle 100. However, the present disclosure is not limited thereto.

The vehicle 100 including the components as described above can detect an obstacle by the detection device 2, and perform automatic parking under the control of the control unit 11 provided in the parking assistance device 1. The automatic parking may be performed based on an instruction given from the occupant via the HMI 4.

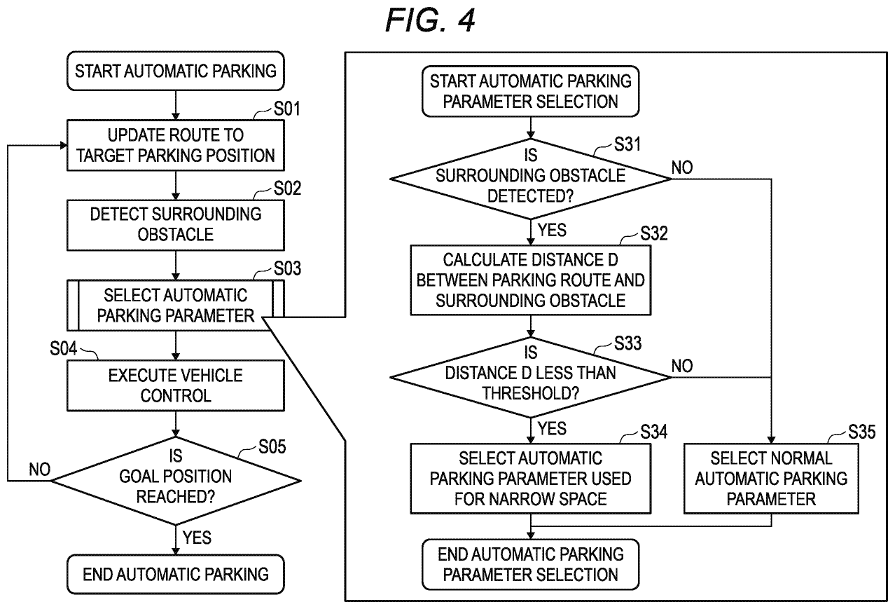

FIG. 4 is a flowchart illustrating an example of automatic parking processing performed by the vehicle 100 including the parking assistance device 1 according to the present disclosure. In this example, an automatic parking parameter is dynamically changed during automatic parking.

In step S01, the control unit 11 updates information (parking route information) indicating a route to a target parking position. The parking route may be calculated by the parking route calculation unit 12 based on an instruction input by a driver or the like of the vehicle 100 via the HMI 4 described above.

Since the vehicle 100 moves during a reversing operation, some change in the situation may occur during the movement. For example, a situation such as one in which a door of an adjacent vehicle is suddenly opened may be considered. Therefore, in this example, a method of moving the vehicle 100 to the target parking position while dynamically updating the parking route after the automatic parking processing is started will be described. When a type of automatic parking processing is performed in which an initially determined parking route is not updated, step S01 may be omitted.

In step S02, the control unit 11 detects an obstacle in the surroundings of the vehicle 100 (hereinafter referred to as a surrounding obstacle). This detection by the control unit 11 can be performed by, for example, the following processing.

First, as described above, the detection device 2 can detect a surrounding obstacle. A detection range thereof can be set as appropriate.

When a surrounding obstacle is detected by the detection device 2, the detection device 2 transmits the above-described obstacle information to the parking assistance device 1. Therefore, when the parking assistance device 1 receives the obstacle information, the control unit 11 can determine in step S02 that a surrounding obstacle is detected.

In step S03, the control unit 11 selects an automatic parking parameter. This automatic parking parameter selection processing includes steps S31 to S35. Steps S31 to S35 will be described later.

In step S04, the travel control device 3 performs vehicle control based on a current value of the automatic parking parameter under the control of the control unit 11. Specifically, an automatic operation of the steering wheel and the accelerator, a quick-turning operation of the vehicle 100, and the like are performed. In the case of parking assist, an automatic operation of the steering wheel is performed.

In step S05, the control unit 11 determines whether the vehicle reaches a goal position of the parking route. When the vehicle reaches the goal position (a case of Yes), the automatic parking processing ends. When the vehicle does not reach the goal position (a case of No), the process shifts to step S01.

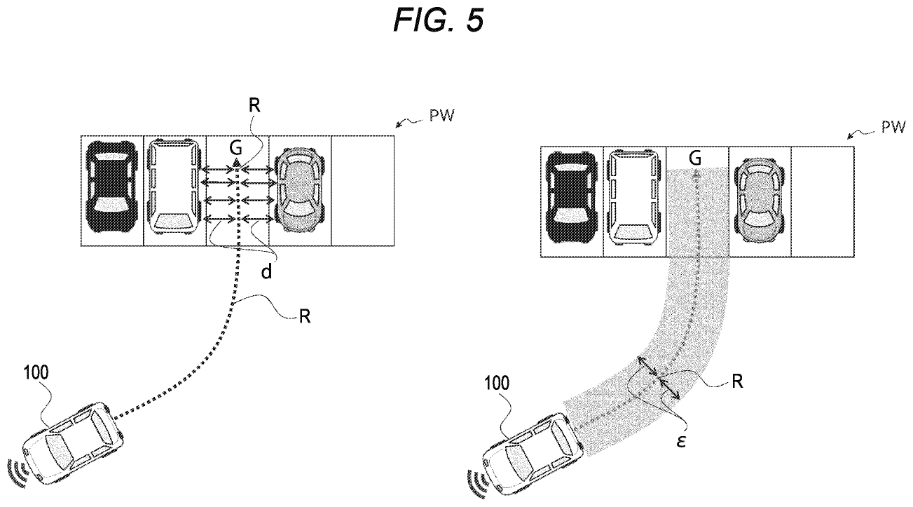

Next, steps S31 to S34 included in the automatic parking parameter selection processing (step S03) will be described. This description will be given also with reference to FIG. 5.

In step S31, the control unit 11 determines whether a surrounding obstacle is detected. When a surrounding obstacle is detected (a case of Yes), the process branches to step S32, and when a surrounding obstacle is not detected (a case of No), the process branches to step S35.

In step S32, the control unit 11 calculates a distance D between a parking route and the surrounding obstacle. An example of a method of calculating the distance D is illustrated in FIG. 5. In FIG. 5, with respect to components same as those in FIGS. 1A, 1B, and 2, a part of reference signs thereof are omitted in order to clarify an important point of description.

Based on the parking route information, the control unit 11 can virtually generate a set of route points R as illustrated in FIG. 5. The route points R may extend to a goal position G that is a parking completion point. Note that a position of the virtually generated route point R is a value known to the control unit 11.

The control unit 11 calculates distances d between the route points R and the surrounding obstacle detected in the previous step S02. This calculation is a two-point distance calculation between the known route point R and an absolute position of the obstacle calculated based on a relative position between the vehicle 100 and the obstacle.

A minimum value of the calculated distances d is the distance D between the parking route and the surrounding obstacle.

Next, in step S33, the control portion 11 determines whether the distance D is less than a predetermined threshold ε. When the distance D is less than the predetermined threshold ε (a case of Yes), the process branches to step S34, and when the distance D is not less than the predetermined threshold ε (a case of No), the process branches to step S35.

To express a branching condition in step S33 based on the distance d instead of the distance D, when there is a route point R at which the distance d is less than the predetermined threshold ε, the process branches to step S34, and when there is no such route point R, the process branches to step S35.

Step S34 is processing performed when the distance D is less than the predetermined threshold ε. At this time, the control unit 11 selects an automatic parking parameter used for a narrow space. For example, a stop determination distance parameter included in the automatic parking parameter is changed to a smaller value.

On the other hand, step S35 is processing performed when the distance D is not less than the predetermined threshold ε. In this case, since there is no obstruction even if the vehicle 100 reverses as it is, a normal automatic parking parameter is selected. For example, the stop determination distance parameter included in the automatic parking parameter is kept to a current value and is not changed.

A magnitude relationship between the predetermined threshold ε, the stop determination distance used for a narrow space (step S34), and the normal stop determination distance (step S35) is, for example, as follows.

stop determination distance used for narrow space<normal stop determination distance≤predetermined threshold ε

As described above, the automatic parking parameter used for a narrow space (step S34) or the normal automatic parking parameter (step S35) is selected. Then, the process shifts to the subsequent step S04.

Then, even if a parking space is a narrow space described above, the automatic parking can be continued based on the automatic parking parameter used for a narrow space.

In the case where it is determined to be automatic parking to a narrow space (a case of Yes in step S33), the changeable automatic parking parameter is not limited to the stop determination distance parameter described above. As described above, other automatic parking parameters include a target speed, a maximum speed (upper limit speed), an acceleration, a deceleration, a PID gain, a stop target distance of automatic braking, a TTC setting time of automatic braking, and the like of the vehicle 100. In step S34, the control unit 11 may additionally change these parameters.

For example, in step S34, a target speed of the vehicle 100 can be reduced to 1 km/h. Since it is parking to a narrow space, a speed of the vehicle 100 is reduced, and automatic parking is performed carefully.

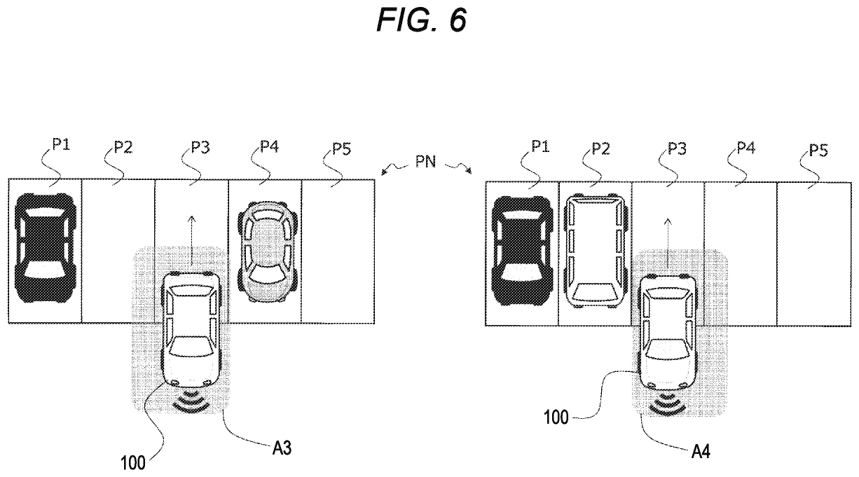

In step S34, the stop determination distance parameters may not be reduced in the same way with respect to the surroundings of the vehicle 100. For example, as illustrated in FIG. 6 illustrating change examples of the automatic parking parameter, an obstacle detected by the detection device 2 may be present only on one of the left and right sides of the vehicle 100 that is performing automatic parking. A direction in which the obstacle is present with respect to the parking route can be specified based on the parking route calculated by the parking route calculation unit 12 and the obstacle information transmitted from the detection device 2 to the control unit 11.

In such a case, in step S34, a value of the stop determination distance parameter may be changed with respect to a direction from the parking route toward the obstacle included in the obstacle information. For example, the area A1 illustrated in FIGS. 1A and 1B may be narrowed to an area A3 or an area A4 illustrated in FIG. 6.

As described above, a parking assistance device may include a control unit and a parking route calculation unit, the parking route calculation unit may calculate a parking route, and the control unit may change a stop determination distance parameter included in an automatic parking parameter based on input obstacle information and parking route information calculated by the parking route calculation unit. In addition, the control unit may change a stop determination distance parameter included in an automatic parking parameter based on a distance between an obstacle included in the obstacle information and a parking route indicated in the parking route information. According to the above configuration, for example, even for a narrow space for which automatic braking is activated and automatic parking cannot be completed, a vehicle including the parking assistance device can complete automatic parking.

In the above configuration, the control unit may change a stop determination distance parameter included in an automatic parking parameter when the distance is less than a predetermined threshold. The control unit may change a stop determination distance parameter included in an automatic parking parameter when a shortest distance between the obstacle and the parking route is less than a predetermined threshold. The control unit may calculate a distance between the obstacle and the parking route for each route point included in the parking route, and may change a stop determination distance parameter included in an automatic parking parameter when there is a route point from which a distance to the obstacle is less than a predetermined threshold. According to the above configuration, by changing a stop determination distance parameter when an obstacle is in a close place, a vehicle including the parking assistance device can complete automatic parking even in a narrow space.

In the above configuration, the stop determination distance parameter may be changed with respect to a direction from the parking route toward an obstacle included in the obstacle information. According to the above configuration, it is possible to safely perform automatic parking by reducing only a stop determination distance parameter of a side on which an obstacle is found among stop determination distance parameters.

In the above configuration, at a time of changing the stop determination distance parameter, the control unit may further change one or more of a target speed, an acceleration, a deceleration, a PID gain, a stop target distance of automatic braking, and a TTC setting time of automatic braking included in an automatic parking parameter. According to the above configuration, when it is determined to be a narrow space, not only a stop determination distance but also various other automatic parking parameters can be changed, so that the automatic parking can be completed more safely.

In addition, in a vehicle including a parking assistance device and a detection unit that detects an obstacle, the parking assistance device including a control unit and a parking route calculation unit, the parking route calculation unit of the parking assistance device may calculate a parking route, the detection unit may detect an obstacle and input obstacle information related to the obstacle to the parking assistance device, and the control unit may change a stop determination distance parameter included in an automatic parking parameter based on the input obstacle information and parking route information calculated by the parking route calculation unit. In addition, the control unit may change a stop determination distance parameter included in an automatic parking parameter based on a distance between an obstacle included in the obstacle information and a parking route indicated in the parking route information. According to the above configuration, the vehicle can complete automatic parking even in a narrow space.

In the above configuration, the control unit may change a stop determination distance parameter included in an automatic parking parameter when the distance is less than a predetermined threshold. The control unit may change a stop determination distance parameter included in an automatic parking parameter when a shortest distance between the obstacle and the parking route is less than a predetermined threshold. The control unit may calculate a distance between the obstacle and the parking route for each route point included in the parking route, and may change a stop determination distance parameter included in an automatic parking parameter when there is a route point from which a distance to the obstacle is less than a predetermined threshold. According to the above configuration, by changing the stop determination distance parameter when the obstacle is in a close place, the vehicle can complete automatic parking even in a narrow space.

In the above configuration, the stop determination distance parameter may be changed with respect to a direction from the parking route toward the obstacle included in the obstacle information. According to the above configuration, it is possible to safely perform automatic parking by reducing only a stop determination distance parameter of a side on which the obstacle is found among stop determination distance parameters.

In the above configuration, at the time of changing the stop determination distance parameter, the control unit may further change one or more of a target speed, an acceleration, a deceleration, a PID gain, a stop target distance of automatic braking, and a TTC setting time of automatic braking included in an automatic parking parameter. According to the above configuration, when it is determined to be a narrow space, not only a stop determination distance but also various other automatic parking parameters can be changed, so that the automatic parking can be completed more safely.

A parking assistance method used by a device including a control unit and a parking route calculation unit may include: a step of calculating a parking route by the parking route calculation unit; and a step of changing, by the control unit, a stop determination distance parameter included in an automatic parking parameter based on input obstacle information and parking route information calculated by the parking route calculation unit. According to the above configuration, a vehicle using the parking assistance method can complete automatic parking even in a narrow space.

In addition, a parking assistance program may cause a device including a control unit and a parking route calculation unit to execute: a step of calculating a parking route by the parking route calculation unit; and a step of changing, by the control unit, a stop determination distance parameter included in an automatic parking parameter based on input obstacle information and parking route information calculated by the parking route calculation unit. According to the above configuration, a vehicle in which the program is installed can complete automatic parking even in a narrow space.

Although various embodiments are described above with reference to the drawings, it is needless to say that the present disclosure is not limited to such examples. For example, the present disclosure can also be applied to valet parking in which a driver gets out of a vehicle and leaves the subsequent parking to the vehicle. It will be apparent to those skilled in the art that various changes and modifications may be conceived within the scope of the claims. It is also understood that the various changes and modifications belong to the technical scope of the present disclosure. Further, components in the above-described embodiments may be combined freely within a range not departing from the spirit of the present disclosure.

The present application is based on Japanese Patent Application No. 2019-055269 filed on Mar. 22, 2019, the contents of which are incorporated herein by reference.

1. A parking assistance device comprising:
a processor; and
a memory having instructions that, when executed by the processor, cause the parking assistance device to perform operations comprising:
calculating a parking route to generate parking route information; and
changing a stop determination distance parameter included in an automatic parking parameter based on obstacle information input to the parking assistance device and the parking route information.

2. The parking assistance device according to claim 1,
wherein the stop determination distance parameter is changed based on a distance between an obstacle included in the obstacle information and the parking route indicated in the parking route information.

3. The parking assistance device according to claim 2,
wherein the stop determination distance parameter is changed in a case in which the distance is less than a threshold.

4. The parking assistance device according to claim 2,
wherein the stop determination distance parameter is changed in a case in which a shortest distance between the obstacle and the parking route is less than a threshold.

5. The parking assistance device according to claim 2,
wherein the operations further comprise calculating the distance between the obstacle and the parking route for each route point included in the parking route, and
wherein the stop determination distance parameter is changed in a case in which there is a route point from which a distance to the obstacle is less than a threshold.

6. The parking assistance device according to claim 1,
wherein the stop determination distance parameter is changed with respect to a direction from the parking route toward an obstacle included in the obstacle information.

7. The parking assistance device according to claim 1,
wherein the operations comprise, at a time of changing the stop determination distance parameter, further changing one or more of a target speed, a maximum speed, an acceleration, a deceleration, a proportional-integral-derivative gain, a stop target distance of automatic braking, and a time-to-collision setting time of automatic braking, which are included in the automatic parking parameter.

8. The parking assistance device according to claim 2,
wherein the changing the stop determination distance parameter comprises:
setting the stop determination distance parameter to a first parameter indicating a first distance in a case in which the distance is less than a threshold; and
setting the stop determination distance parameter to a second parameter indicating a second distance greater than the first distance in a case in which the distance is equal to or greater than the threshold.

9. The parking assistance device according to claim 8,
wherein the second distance is equal to or less than the threshold.

10. A vehicle comprising:
a parking assistance device comprising a processor and a memory; and
a detector,
wherein the instructions, when executed by the processor, cause the parking assistance device to perform operations comprising:
calculating a parking route to generate parking route information; and
changing a stop determination distance parameter included in an automatic parking parameter based on obstacle information related to an obstacle detected by the detector input to the parking assistance device and the parking route information.

11. The vehicle according to claim 10,
wherein the stop determination distance parameter is changed based on a distance between the obstacle included in the obstacle information and the parking route indicated in the parking route information.

12. The vehicle according to claim 11,
wherein the stop determination distance parameter is changed in a case in which the distance is less than a threshold.

13. The vehicle according to claim 11,
wherein the stop determination distance parameter is changed in a case in which a shortest distance between the obstacle and the parking route is less than a threshold.

14. The vehicle according to claim 11,
wherein the operations further comprise calculating the distance between the obstacle and the parking route for each route point included in the parking route, and
wherein the stop determination distance parameter is changed in a case in which there is a route point from which a distance to the obstacle is less than a threshold.

15. The vehicle according to claim 10,
wherein the stop determination distance parameter is changed with respect to a direction from the parking route toward the obstacle included in the obstacle information.

16. The vehicle according to claim 10,
wherein the operations comprise, at a time of changing the stop determination distance parameter, further changing one or more of a target speed, a maximum speed, an acceleration, a deceleration, a proportional-integral-derivative gain, a stop target distance of automatic braking, and a time-to-collision setting time of automatic braking, which are included in the automatic parking parameter.

17. The vehicle according to claim 11,
wherein the changing the stop determination distance parameter comprises:
setting the stop determination distance parameter to a first parameter indicating a first distance in a case in which the distance is less than a threshold; and
setting the stop determination distance parameter to a second parameter indicating a second distance greater than the first distance in a case in which the distance is equal to or greater than the threshold.

18. The vehicle according to claim 17,
wherein the second distance is equal to or less than the threshold.

19. A parking assistance method used by a parking assistance device, the parking assistance method comprising:
calculating a parking route to generate parking route information; and
changing a stop determination distance parameter included in an automatic parking parameter based on obstacle information input to the parking assistance device and the parking route information.

20. A non-transitory computer-readable medium storing a parking assistance program that, when executed by a processor, causes a computer to perform operations comprising:
calculating a parking route to generate parking rout information; and
changing a stop determination distance parameter included in an automatic parking parameter based on obstacle information input to the computer and the parking route information.
